(19) United States
(12) Patent Application Publication
(10) Pub. No.: US 2009/0261666 A1
(43) Pub. Date: Oct. 22, 2009

(54) Radially Balanced Stator Forces for a Spindle Motor

(76) Inventors: Jonathan K.J. Wong, Singapore (SG); Choon Hoe Koh, Singapore (SG); Natarajan Swaminathan, Singapore (SG)

Correspondence Address: WAX LAW GROUP, 1017 L STREET #425, SACRAMENTO, CA, 95814, US

(21) Appl. No.: 12/105,175

(22) Filed: Apr. 17, 2008

(51) Int. Cl. H02K 1/06; H02K 5/24; H02K 1/16; H02P 6/00

(52) U.S. Cl. 310/51; 318/700; 310/198

(57) ABSTRACT

A spindle motor is provided for reducing or eliminating RRO and NRRO. Radial forces on the spindle motor are reduced or eliminated, and the net rotational torque is increased. Read and write heads may be placed increasingly closer to a memory storage disc surface, and are accurately aligned with the disc storage tracks. This allows increased track densities, and also allows for smaller discs and increased storage capacity of discs. In an aspect, a first stator tooth and a second stator tooth are positioned to generate substantially equal and opposite radial forces on the spindle motor. The first and second stator teeth are also simultaneously energized to cause the interaction of the stator with the magnet. In another aspect, the first stator tooth is positioned 180 degrees circumferentially about the stator from the second stator tooth, and axially above the second stator tooth.

### BACKGROUND

Disc drive memory systems store digital information that is recorded on concentric tracks of a magnetic disc medium. At least one disc is rotatably mounted on a spindle, and the information, which can be stored in the form of magnetic transitions within the discs, is accessed using read/write heads or transducers. A drive controller is conventionally used for controlling the disc drive system based on commands received from a host system. The drive controller controls the disc drive to store and retrieve information from the magnetic discs. The read/write heads are located on a pivoting arm that moves radially over the surface of the disc. The discs are rotated at high speeds during operation using an electric motor located inside a hub or below the discs. One type of motor has a spindle mounted by means of a bearing system to a motor shaft disposed in the center of the hub. The bearings permit rotational movement between the shaft and the sleeve, while maintaining alignment of the spindle to the shaft. Because rotational accuracy is critical, disc drives utilize a motor having fluid dynamic bearings (FDB) between a shaft and sleeve to support a hub and the disc for rotation. In a hydrodynamic bearing, a lubricating fluid such as gas or liquid provides a bearing surface between a fixed member and a rotating member of the disc drive.

Disc drive memory systems are being utilized in progressively more environments besides traditional stationary computing environments. Recently, disc drive memory systems are incorporated into devices that are operated in digital cameras, digital video cameras, video game consoles, personal music players, in addition to portable computers. As such, performance and design needs have intensified. A demand exists for increased storage capacity and smaller disc drives, which has led to the design of higher recording a real density such that the read/write heads are placed increasingly closer to the disc surface. The read/write heads must be accurately aligned with the storage tracks on the disc to ensure the proper reading and writing of information.

A slight wobble or run-out in disc rotation occurring during the operation of the motor can cause the disc to strike the read/write head, possibly damaging the disc drive and resulting in loss of data. Concerns of repeatable run-out (RRO) and non-repeatable runout (NRRO) errors limit data track density and overall performance of the disc drive system. Five percent of a track pitch is usually the limit of regulation for servo tracking. Reduction of NRRO is critical, especially since disc magnetic track densities are often greater than 105,000 tracks per inch (TPI).

### SUMMARY

The present invention provides a novel stator for a spindle motor. In an embodiment, a bearing is defined between a stationary component and a rotatable component, wherein the stationary component and the rotatable component are positioned for relative rotation. A stator is affixed to the stationary component, the stator including a first stator tooth and a second stator tooth. The first stator tooth includes a first phase winding about a first laminator, and the second stator tooth includes a second phase winding about a second laminator. A magnet is affixed to the rotatable component to interact with the stator to cause rotation of the rotatable component. The first phase winding and the second phase winding are simultaneously energized to cause the interaction of the stator with the magnet for a net rotational torque. The first stator tooth is positioned to generate a first radial force on the spindle motor, and the second stator tooth is positioned to generate a second radial force on the spindle motor. The first radial force on the spindle motor is substantially equal and opposite of the second radial force on the spindle motor. These and various other features and advantages will be apparent from a reading of the following detailed description.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a top plan view of a disc drive data storage system in which the present invention is useful, in accordance with an embodiment of the present invention;

FIG. 2 is a sectional side view of a contemporary hydrodynamic bearing motor used in a disc drive data storage system;

FIG. 3 is a top plan view of a contemporary 6-step stator and magnet design as used in a spindle motor;

FIG. 4 is a top plan view of a contemporary 9-step stator and magnet design as used in a spindle motor;

FIG. 5A is a force vector diagram of the contemporary 6-step motor design as in FIG. 3, illustrating a resulting radial force on the spindle motor due to the unbalanced radial forces;

FIG. 5B is a force vector diagram of the contemporary 6-step motor design as in FIG. 3, illustrating the resulting force vectors when the three phases are simultaneously fired at 120 degrees apart;

FIG. 6 is a top plan view of a radially balanced 6-step stator and magnet design for use in a spindle motor, in accordance with an embodiment of the present invention;

FIG. 7 is a top plan view of another radially balanced 6-step stator and magnet design having corresponding axially displaced stator teeth for use in a spindle motor, in accordance with an embodiment of the present invention;

FIG. 8 is a top plan view of a radially balanced 18-step stator and magnet design for use in a spindle motor, in accordance with an embodiment of the present invention;

FIG. 9 is a force vector diagram of a 6-step design as in FIG. 6, illustrating a net cancelled resulting radial force and a net doubled torque force when the two phases are simultaneously fired at 180 degrees apart, in accordance with an embodiment of the present invention; and

FIG. 10 is a force vector diagram of a 6-step design as in FIG. 7, illustrating a net cancelled resulting radial force on the spindle motor due to the balanced radial forces, in accordance with an embodiment of the present invention.

### DETAILED DESCRIPTION

Exemplary embodiments are described with reference to specific configurations. Those of ordinary skill in the art will appreciate that various changes and modifications can be made while remaining within the scope of the appended claims. Additionally, well-known elements, devices, components, methods, process steps and the like may not be set forth in detail in order to avoid obscuring the invention.

Non-repeatable runout (NRRO) errors are often caused by radial runout of precision fluid dynamic bearings. For a conventional fluid dynamic bearing motor, NRRO is usually attributed to defects in the bearing. In the past, analyses have been performed in the time and frequency domains of NRRO to devise methods that reduce NRRO. Also, strategies including damping and using a higher cost and higher performance motor have been attempted, although NRRO remained an issue to overcome. A current problem with NRRO and repeatable runout (RRO) in spindle motors is in part due to the firing pattern of an excitation bridge, which generates a continuously changing and unequal net radial force on the spindle, in order to generate a rotating magnetic field.

A system and method are described herein for reducing or eliminating RRO and NRRO for spindle motors and fluid dynamic bearing motors with minimal or no increase in cost or complexity. In an embodiment, radial forces on the spindle are reduced or eliminated, and the motor maintains a net rotating force with a conventional torque increased by a factor of two. As such, the read/write heads may be placed increasingly closer to the disc surface, and the read/write heads are accurately aligned with the storage tracks on the disc, ensuring the proper reading and writing of information. This allows discs to be designed with increased track densities, and also allows for smaller discs and/or increased storage capacity of discs. The overall performance of the disc drive system is increased, and vibration and wear of the motor is reduced.

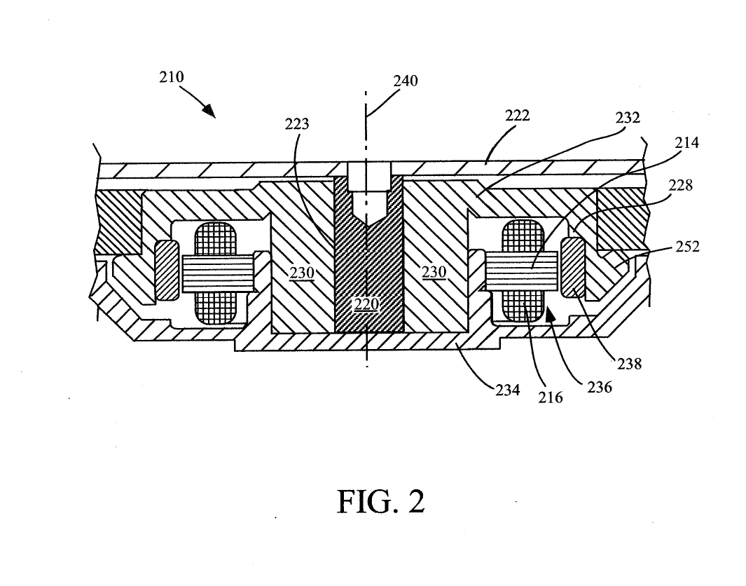

It will be apparent that features of the discussion and claims may be utilized with disc drive memory systems, low profile disc drive memory systems, spindle motors, various fluid dynamic bearing designs including hydrodynamic and hydrostatic bearings, and other motors employing a stationary and a rotatable component, including motors employing conical bearings. Further, embodiments of the present invention may be employed with a fixed shaft or a rotating shaft. In an embodiment, the present invention is employed with a brushless direct current (BLDC) motor. Also, as used herein, the terms “axially” or “axial direction” refers to a direction along a centerline axis length of the shaft (i.e., along axis 240 of shaft 220 shown in FIG. 2), and “radially” or “radial direction” refers to a direction perpendicular to the centerline axis 240. Also, as used herein, the expressions indicating orientation such as “upper”, “lower”, “top”, “bottom”, “height” and the like, are applied in a sense related to normal viewing of the figures rather than in any sense of orientation during particular operation, etc. These orientation labels are provided simply to facilitate and aid understanding of the figures as described in this Description and should not be construed as limiting.

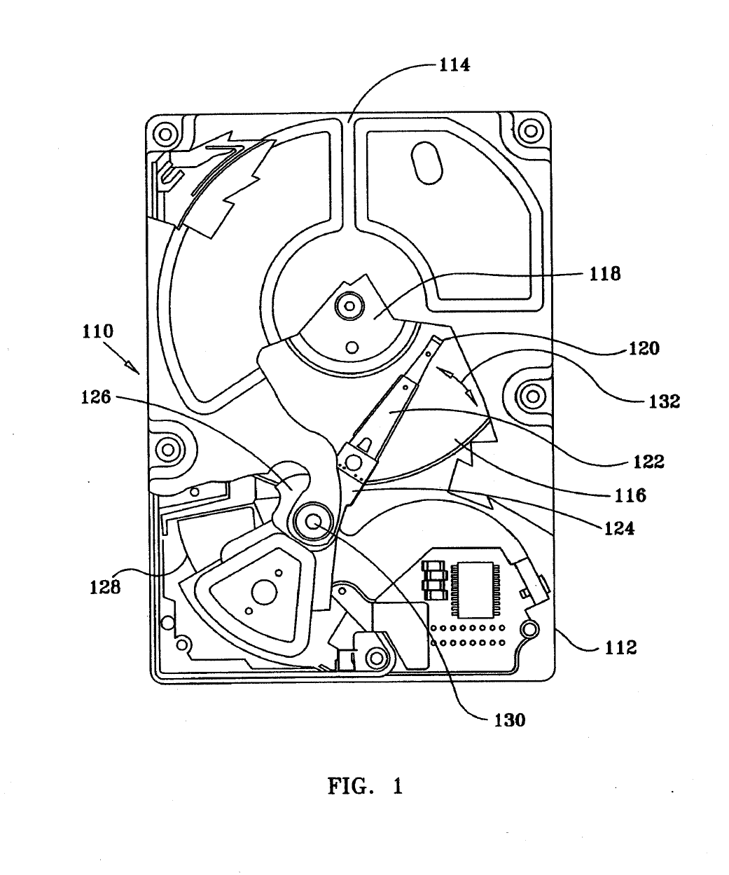

Referring to the drawings wherein identical reference numerals denote the same elements throughout the various views, FIG. 1 illustrates a top plan view of a typical disc drive data storage system 110 in which the present invention is useful. Clearly, features of the discussion and claims are not limited to this particular design, which is shown only for purposes of the example. Disc drive 110 includes housing base 112 that is combined with cover 114 forming a sealed environment to protect the internal components from contamination by elements outside the sealed environment. Disc drive 110 further includes disc pack 116, which is mounted for rotation on a spindle motor (described in FIG. 2) by disc clamp 118. Disc pack 116 includes a plurality of individual discs, which are mounted for co-rotation about a central axis. Each disc surface has an associated head 120 (read head and write head), which is mounted to disc drive 110 for communicating with the disc surface. In the example shown in FIG. 1, heads 120 are supported by flexures 122, which are in turn attached to head mounting arms 124 of actuator body 126. The actuator shown in FIG. 1 is a rotary moving coil actuator and includes a voice coil motor, shown generally at 128. Voice coil motor 128 rotates actuator body 126 with its attached heads 120 about pivot shaft 130 to position heads 120 over a desired data track along arc path 132. This allows heads 120 to read and write magnetically encoded information on the surfaces of discs 116 at selected locations.

A flex assembly provides the requisite electrical connection paths for the actuator assembly while allowing pivotal movement of the actuator body 126 during operation. The flex assembly (not shown) terminates at a flex bracket for communication to a printed circuit board mounted to the bottom side of disc drive 110 to which head wires are connected; the head wires being routed along the actuator arms 124 and the flexures 122 to the heads 120. The printed circuit board typically includes circuitry for controlling the write currents applied to the heads 120 during a write operation and a preamplifier for amplifying read signals generated by the heads 120 during a read operation.

Referring to FIG. 2, a sectional side view is illustrated of a contemporary hydrodynamic bearing motor 210, as used in a disc drive data storage system 110 as in FIG. 1. The motor includes stationary components that are relatively rotatable with rotatable components, defining a journal bearing 223 therebetween. In this example, the stationary components include shaft 220, top cover 222, and stator 236, which is affixed to base plate 234. Stator 236 is comprised of lamination core 214 and phase windings 216. The rotatable components include sleeve 230, hub 232 and magnet 238. Hub 232 includes a disc flange 252, which supports disc pack 116 (shown in FIG. 1) for rotation about shaft 220. Hub 232 is integral with backiron 228. One or more magnets 238 are attached to a periphery of backiron 228. The magnets 238 interact with stator 236 attached to the base 234 to cause a controlled rotation of the hub 232. Magnet 238 can be formed as a unitary, annular ring or can be formed of a plurality of individual magnets that are spaced about the periphery of hub 232. Magnet 238 is magnetized to form one or more magnetic poles. A journal bearing 223 is established between the rotating sleeve 230 and the stationary shaft 220. In the case of a fluid dynamic journal bearing, a fluid, such as lubricating oil fills interfacial regions between sleeve 230 and shaft 220 as well as between other stationary and rotatable components. Other useable fluids include a lubricating liquid or gas, or a combination of a lubricating liquid and lubricating gas.

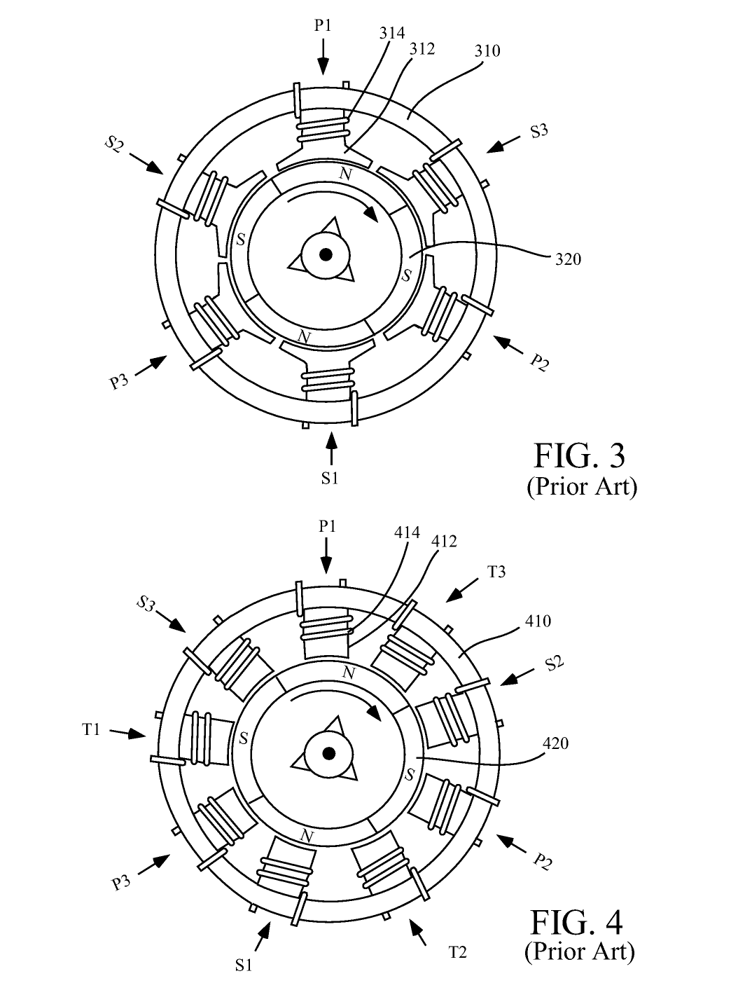

FIG. 3 is a top plan view of a contemporary 6-step stator and magnet design as used in a spindle motor. Motor drive circuitry controls the timing and the power of commutation pulses directed to the stator phase windings 314. These commutation pulses are timed pulses directed to sequentially selected phase windings 314 to generate a rotating magnetic field that communicates with magnet 320 and causes magnet 320 and hub to rotate about a central axis on a bearing at a predetermined rotational speed. As the hub rotates, the head engages in reading or writing instructions. However, in contemporary motors, in the application and removal of the commutation pulses, the firing pattern of an excitation bridge generates a continuously changing and unequal net radial force on the rotational component and on the entire spindle motor. The stator includes six separate stator teeth (indicated as P1, P2, P3, S1, S2, and S3), each stator tooth having phase windings 314 that are wrapped around a lamination core 312. The stator is attached to baseplate 310, and magnet 320 is positioned radially inside of the stator. The stator teeth are situated 60 degrees apart circumferentially about the stator. The firing pattern is directed to one reference phase and two other phases, wherein the three phases are 120 degrees apart circumferentially about the stator. For example, the firing pattern is simultaneously directed to stator tooth P1, P2 and P3, each 120 degrees apart circumferentially about the stator. Next, the firing pattern is simultaneously directed to stator tooth S1, S2 and S3, each 120 degrees apart circumferentially about the stator. This firing pattern can generate a continuously changing and unequal net radial force on the spindle motor, causing RRO and NRRO problems in the motor.

FIG. 4 is a top plan view of a contemporary 9-step stator and magnet design as used in a spindle motor. The stator includes nine separate stator teeth (indicated as P1, P2, P3, S1, S2, S3, T1, T2 and T3), each stator tooth having a stator lamination core 412 and phase windings 414 that are wrapped around a lamination core 412. The stator is attached to baseplate 410, and magnet 420 is positioned radially inside of the stator. The stator teeth are situated 40 degrees apart circumferentially about the stator. The firing pattern is directed to one reference phase and two other phases, wherein the three phases are 120 degrees apart circumferentially about the stator. For example, the firing pattern is simultaneously directed to stator tooth P1, P2 and P3, each 120 degrees apart circumferentially about the stator. Next, the firing pattern is simultaneously directed to stator tooth S1, S2 and S3, each 120 degrees apart circumferentially about the stator. And next, the firing pattern is simultaneously directed to stator tooth T1, T2 and T3, each 120 degrees apart circumferentially about the stator. This firing pattern can generate a continuously changing and unequal net radial force on the spindle motor, causing RRO and NRRO problems in the motor.

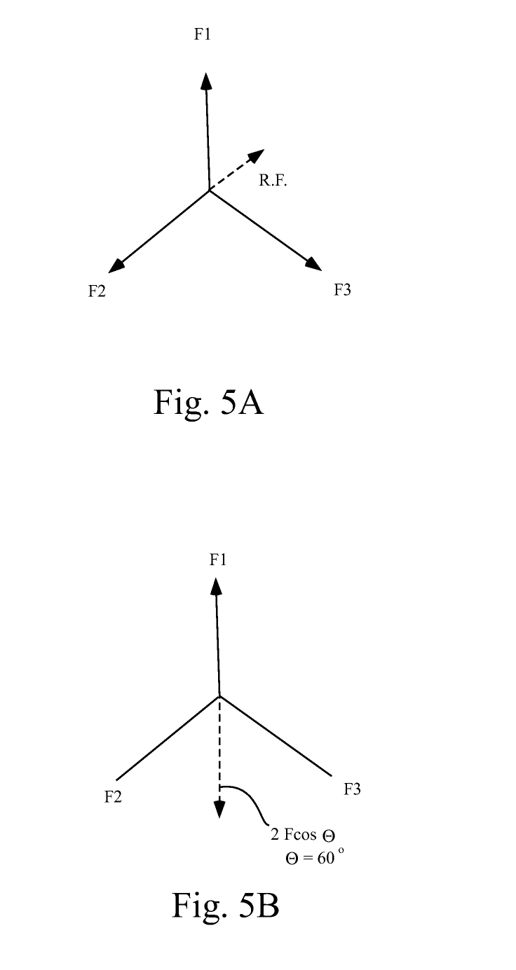

As illustrated in FIG. 5A, radial forces (RF) result on the rotational component and on the entire spindle motor due to the unbalanced radial forces as shown in the force vector diagram of a contemporary 6-step motor design as in FIG. 3. Forces F1, F2 and F3 are affected by the non-symmetry of the rotor structure, imbalance of the rotor phase windings, and the amount of current flowing to each phase winding. F1, F2 and F3 are continuously changing, resulting in a random net radial force that changes in direction with respect to the centerline axis length of the shaft. As a result, a random radial force pulls the motor spindle away from the centerline axis length of the shaft, causing RRO and NRRO problems in the motor.

As illustrated in FIG. 5B, radial forces result when three stator tooth phases at 120 degrees apart are simultaneously fired as shown in the force vector diagram of a contemporary 6-step motor design as in FIG. 3. In this example, F1 corresponds with P1, F2 corresponds with P2, and F3 corresponds with P3, as in FIG. 3. The resulting forces created are F1 and 2 F cos θ, where 0 is 60 degrees. The resulting radial imbalance of forces causes RRO and NRRO problems in the motor.

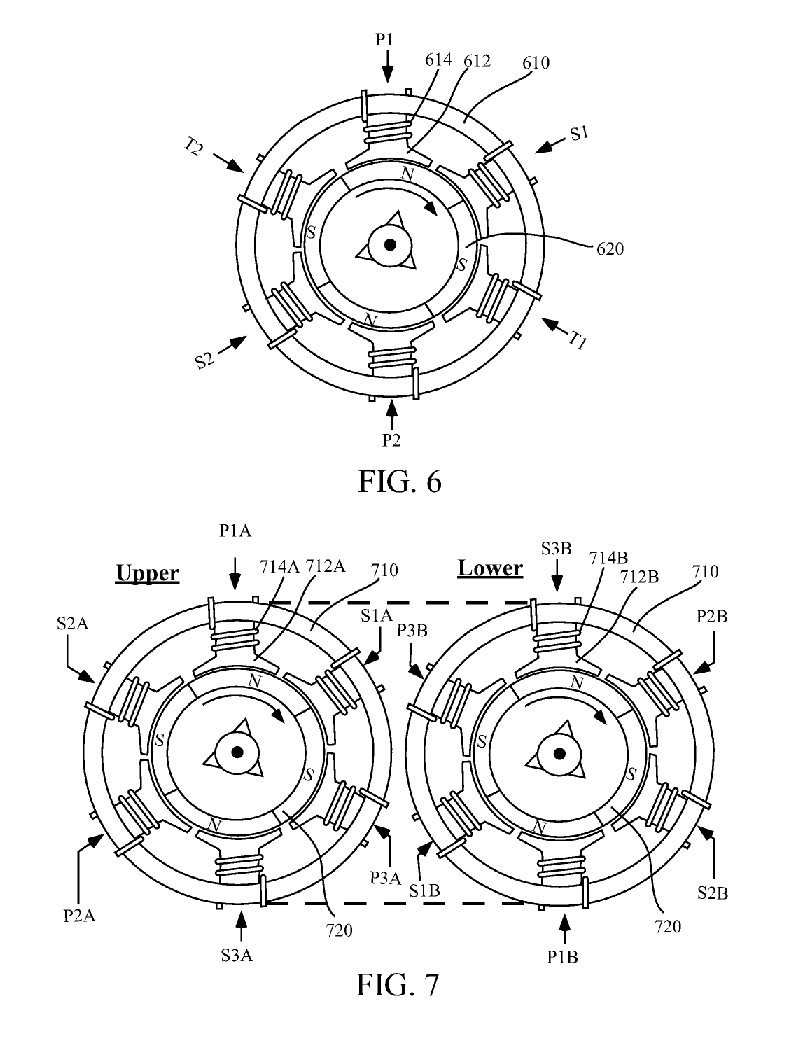

Referring to FIG. 6, a top plan view is shown of a radially balanced 6-step stator and magnet design for use in a spindle motor, in accordance with an embodiment of the present invention. In this example, the stator has six stator teeth, namely P1, P2, P3, S1, S2, and S3. Each stator tooth includes a phase winding 614 that is wrapped around a lamination core 612. The stator is attached to baseplate 610, and magnet 620 is positioned radially inside of the stator. In an alternative embodiment, the magnet is positioned radially outside of the stator. The stator teeth are situated 60 degrees apart circumferentially about the stator. The firing pattern or commutation pulses are directed simultaneously to a first primary stator tooth P1 and a second primary stator tooth P2 to cause the interaction of the stator with the magnet for a net rotational torque. Next, the firing pattern is simultaneously directed to stator teeth S1 and S2, and subsequently the firing pattern is simultaneously directed to stator teeth T1 and T2. The phase windings 614 can be energized by pulse width modulation. Additionally, the first primary stator tooth P1 is positioned to generate a first radial force on the spindle motor, and the second primary stator tooth P2 is positioned to generate a second radial force on the spindle motor. In an embodiment, the second primary stator tooth P2 is situated at 180 degrees circumferentially about the stator from the first primary stator tooth P1. In an alternative embodiment, in a skewed laminator design, the P2 laminator, and not the P2 phase winding is positioned 180 degrees circumferentially about the stator from the P1 laminator, since in this design the laminator specifically interacts with the magnet. The first radial force generated by P1 on the spindle motor is substantially equal and opposite of the second radial force generated by P2 on the spindle motor. Likewise, the radial force generated by S1 on the spindle motor is substantially equal and opposite of the radial force generated by S2 on the spindle motor. Further, the radial force generated by T 1 on the spindle motor is substantially equal and opposite of the radial force generated by T2 on the spindle motor. An equal net radial force on the rotatable component and/or on the spindle motor may be generated, thereby reducing or eliminating any RRO and NRRO problems in the motor.

In an embodiment, the phase winding of the first primary stator tooth P1 is energized substantially the same as the phase winding of the second primary stator tooth P2, to generate a first primary stator tooth P1 phase winding rotating force that is substantially similar to a second primary stator tooth P2 phase winding rotating force. In another embodiment, the first primary stator tooth P1 creates a first magnetic field, and the second primary stator tooth P2 creates a second magnetic field, wherein the first magnetic field and the second magnetic field are separate. In yet another embodiment, the stator is bonded to a baseplate as a composite component to reduce vibration of the motor.

FIG. 7 shows a top plan view of another radially balanced 6-step stator and magnet design having corresponding axially displaced stator teeth for use in a spindle motor, in accordance with an embodiment of the present invention. In this example, the stator has six upper stator teeth, namely P1A, P2A, P3A, S1A, S2A, and S3A, and six lower stator teeth, namely P1B, P2B, P3B, S1B, S2B, and S3B. The upper stator teeth together with the lower stator teeth cause the interaction of the stator with the magnet for a net rotational torque. The upper stator teeth are positioned axially above the lower stator teeth. In an embodiment, P1A is situated 180 degrees circumferentially about the stator from P1B, P2A is situated 180 degrees circumferentially about the stator from P2B, P3A is situated 180 degrees circumferentially about the stator from P3B, S1A is situated 180 degrees circumferentially about the stator from S1B, S2A is situated 180 degrees circumferentially about the stator from S2B, and S3A is situated 180 degrees circumferentially about the stator from S3B. Each upper stator tooth includes a phase winding 714A that is wrapped around a lamination core 712A, and each lower stator tooth includes a phase winding 714B that is wrapped around a lamination core 712B. The upper stator teeth and the lower stator teeth are attached to baseplate 710, and magnet 720 is positioned radially inside of the stator. In an alternative embodiment, the magnet is positioned radially outside of the stator.

The stator teeth are situated 60 degrees apart circumferentially about the stator. As an example, the firing pattern or commutation pulses are directed simultaneously to all of the following: upper stator teeth P1A, P2A and P3A, and lower stator teeth P1B, P2B and P3B. The radial force generated by P1A on the spindle motor is substantially equal and opposite of the radial force generated by P1B on the spindle motor. Likewise, the radial forces generated by P2A and P3A on the spindle motor are substantially equal and opposite of the radial forces generated by P2B and P3B on the spindle motor.

Next, the firing pattern or commutation pulses are directed simultaneously to all of the following: upper stator teeth S1A, S2A and S3A, and lower stator teeth S1B, S2B and S3B. The radial force generated by S1A on the spindle motor is substantially equal and opposite of the radial force generated by SIB on the spindle motor. Likewise, the radial forces generated by S2A and S3A on the spindle motor are substantially equal and opposite of the radial forces generated by S2B and S3B on the spindle motor. An equal net radial force on the spindle motor may be generated, thereby reducing or eliminating any RRO and NRRO problems in the motor. In an embodiment, a conventional commutation pulse control circuit and excitation bridge may be used to direct the commutation pulses to the stator teeth.

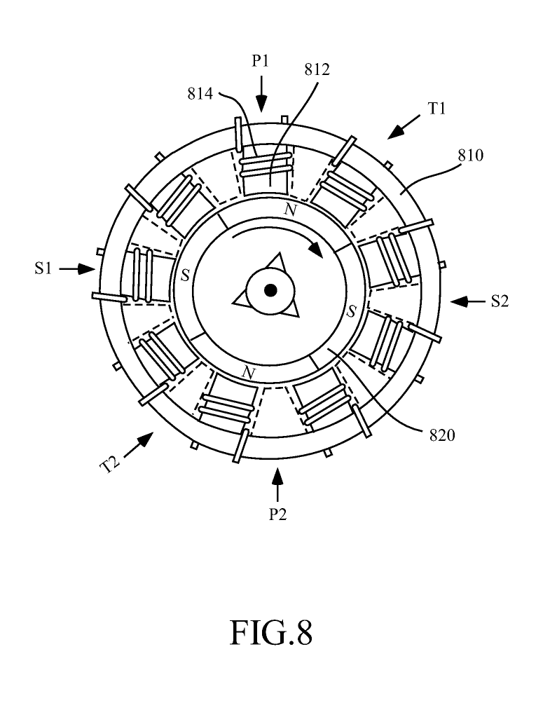

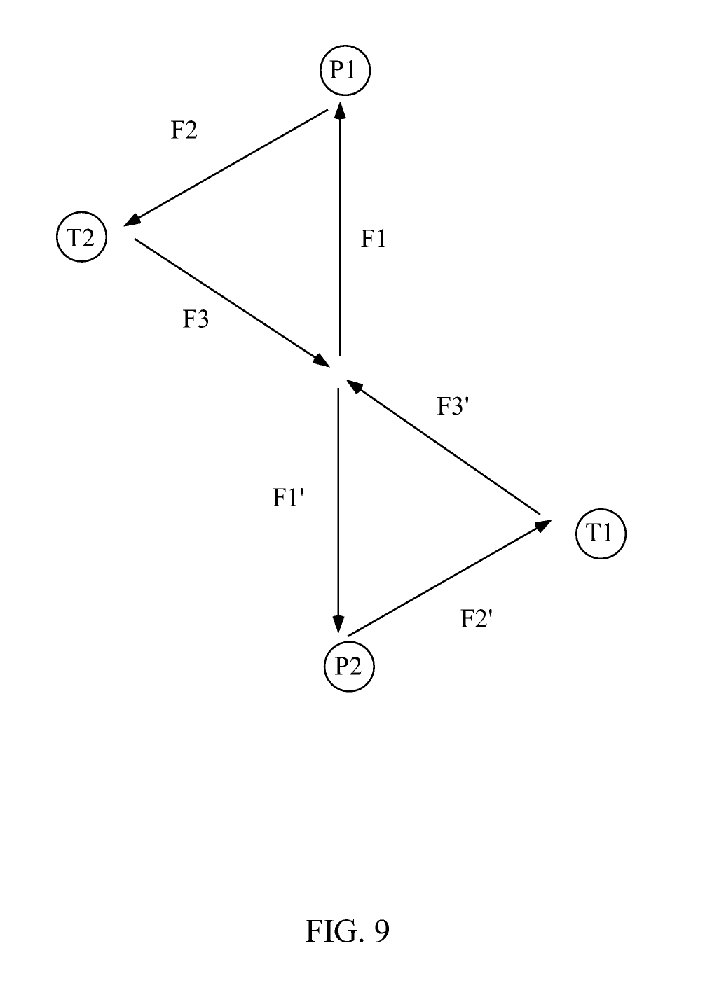

Turning now to FIG. 8, a top plan view is illustrated of a radially balanced 18-step stator and magnet design for use in a spindle motor, in accordance with an embodiment of the present invention. In this example, the stator has eighteen stator teeth. Each stator tooth includes a phase winding 814 that is wrapped around a lamination core 812. The stator is attached to baseplate 810, and magnet 820 is positioned radially inside of the stator. In an alternative embodiment, the magnet is positioned radially outside of the stator.

The firing pattern or commutation pulses are directed simultaneously to a first primary stator tooth P1 and a second primary stator tooth P2 to cause the interaction of the stator with the magnet for a net rotational torque. Next, the firing pattern is simultaneously directed to stator teeth S1 and S2, and subsequently the firing pattern is simultaneously directed to stator teeth T 1 and T2. This firing pattern continues with another set of stator teeth, each stator tooth 180 degrees circumferentially about the stator from the other simultaneously fired stator tooth. The radial forces on the spindle motor generated by the 180 degree opposite, simultaneously fired, stator teeth is substantially equal and opposite. An equal net radial force on the spindle motor may be generated, thereby reducing or eliminating any RRO and NRRO problems in the motor.

In an alternative embodiment, the stator teeth (denoted by dotted lines) are placed on a different axial plane as the stator teeth (denoted by a solid line). This may be employed for space considerations.

FIG. 9 is a force vector diagram of a 6-step design as in FIG. 6, illustrating a net cancelled resulting radial force and a net doubled torque force when the two phases are simultaneously fired at 180 degrees apart, in accordance with an embodiment of the present invention. Stator teeth P1, P2, T1, and T2 correspond to those stators shown in FIG. 6. The radial force (F1) generated by P1 on the spindle motor is substantially equal and opposite of the radial force (F1′) generated by P2 on the spindle motor. Likewise, the radial force (F3′) generated by T1 on the spindle motor is substantially equal and opposite of the radial force (F3) generated by T2 on the spindle motor. As a result, there is reduction or elimination of a random radial force that pulls the motor spindle away from the centerline axis length of the shaft, thereby reducing or eliminating RRO and NRRO problems in the motor. Also, the rotational torques F2 and F2′ together double the net rotational torque on the motor, enabling faster acceleration and higher rotational speeds. This is useful during motor start up and also creates a more robust motor during external disturbances.

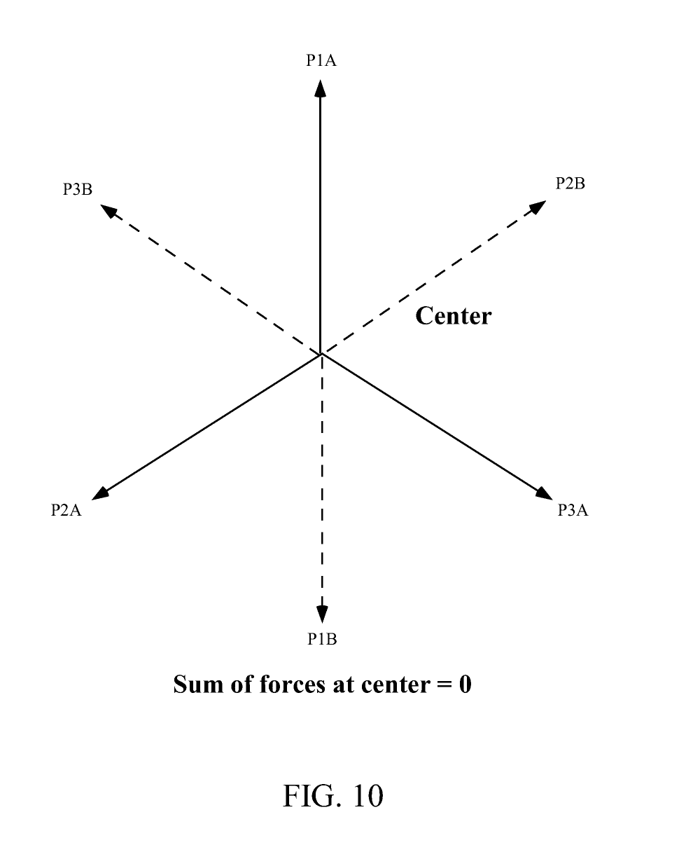

FIG. 10 is a force vector diagram of a 6-step design as in FIG. 7, illustrating a net cancelled resulting radial force on a spindle motor due to the balanced radial forces, in accordance with an embodiment of the present invention. Forces P1A, P1B, P2A, P2B, P3A, and P3B correspond to those stators shown in FIG. 7. The radial force generated by P1A on the spindle motor is substantially equal and opposite of the radial force generated by P1B on the spindle motor. Likewise, the radial forces generated by P2A and P3A on the spindle motor are substantially equal and opposite of the radial forces generated by P2B and P3B on the spindle motor. As a result, there is reduction or elimination of a random radial force that pulls the motor spindle away from the centerline axis length of the shaft, thereby reducing or eliminating RRO and NRRO problems in the motor.

Modifications and variations may be made to the disclosed embodiments while remaining within the spirit and scope of the invention. The implementations described above and other implementations are within the scope of the following claims.

We claim:

1. A spindle motor comprising:
a bearing defined between a stationary component and a rotatable component, wherein the stationary component and the rotatable component are positioned for relative rotation;
a stator, affixed to the stationary component, the stator comprising a first stator tooth and a second stator tooth, the first stator tooth comprising a first phase winding about a first laminator, and the second stator tooth comprising a second phase winding about a second laminator; and
a magnet affixed to the rotatable component to interact with the stator to cause rotation of the rotatable component, wherein the first phase winding and the second phase winding are simultaneously energized to cause the interaction of the stator with the magnet for a net rotational torque, wherein the first stator tooth is positioned to generate a first radial force on the spindle motor, and the second stator tooth is positioned to generate a second radial force on the spindle motor, and wherein the first radial force on the spindle motor is substantially equal and opposite of the second radial force on the spindle motor.

2. The spindle motor as in claim 1, wherein the second stator tooth is situated at 180 degrees circumferentially about the stator from the first stator tooth.

3. The spindle motor as in claim 1, wherein the first stator tooth is positioned axially above or axially below the second stator tooth.

4. The spindle motor as in claim 2, further comprising a third stator tooth including a third phase winding about a third laminator, and a fourth stator tooth including a fourth phase winding about a fourth laminator, wherein the third stator tooth is situated at 180 degrees circumferentially about the stator from the fourth stator tooth, and wherein the first stator tooth and the second stator tooth are positioned axially above or axially below the third stator tooth and the fourth stator tooth.

5. The spindle motor as in claim 1, wherein the first stator tooth creates a first magnetic field, and the second stator tooth creates a second magnetic field, wherein the first magnetic field and the second magnetic field are separate.

6. The spindle motor as in claim 1, wherein the second phase winding is energized substantially the same as the first phase winding, to generate a second phase winding rotating force that is substantially similar to a first phase winding rotating force.

7. The spindle motor as in claim 1, wherein the first phase winding and the second phase winding are energized by pulse width modulation.

8. The spindle motor as in claim 1, wherein the stationary component further comprises a baseplate, wherein the stator is bonded to the baseplate as a composite component to reduce vibration of the motor.

9. The spindle motor as in claim 1, further comprising a data storage disc attached to one of the stationary component and the rotatable component, and an actuator supporting a head proximate to the data storage disc for communicating with the data storage disc.

10. A brushless direct current (BLDC) motor comprising:
a bearing defined between a stationary component and a rotatable component, wherein the stationary component and the rotatable component are positioned for relative rotation;
a stator, affixed to the stationary component, the stator comprising a first stator tooth and a second stator tooth, the first stator tooth comprising a first phase winding about a first laminator, and the second stator tooth comprising a second phase winding about a second laminator; and
a magnet affixed to the rotatable component to interact with the stator to cause rotation of the rotatable component, wherein the first phase winding and the second phase winding are simultaneously energized to cause the interaction of the stator with the magnet for a net rotational torque, wherein the first stator tooth is positioned to generate a first radial force on the BLDC motor, and the second stator tooth is positioned to generate a second radial force on the BLDC motor, and wherein the first radial force on the BLDC motor is substantially equal and opposite of the second radial force on the BLDC motor.

11. The BLDC motor as in claim 10, wherein the second stator tooth is situated at 180 degrees circumferentially about the stator from the first stator tooth.

12. The BLDC motor as in claim 10, wherein the first stator tooth is positioned axially above or axially below the second stator tooth.

13. The BLDC motor as in claim 11, further comprising a third stator tooth including a third phase winding about a third laminator, and a fourth stator tooth including a fourth phase winding about a fourth laminator, wherein the third stator tooth is situated at 180 degrees circumferentially about the stator from the fourth stator tooth, and wherein the first stator tooth and the second stator tooth are positioned axially above or axially below the third stator tooth and the fourth stator tooth.

14. The BLDC motor as in claim 10, wherein the first stator tooth creates a first magnetic field, and the second stator tooth creates a second magnetic field, wherein the first magnetic field and the second magnetic field are separate.

15. The BLDC motor as in claim 10, wherein the second phase winding is energized substantially the same as the first phase winding, to generate a second phase winding rotating force that is substantially similar to a first phase winding rotating force.

16. The BLDC motor as in claim 10, wherein the first phase winding and the second phase winding are energized by pulse width modulation.

17. In a spindle motor having a bearing defined between a stationary component and a rotatable component, wherein the stationary component and the rotatable component are positioned for relative rotation, a method comprising:
interacting a magnet, affixed to the rotatable component, with a stator, affixed to the stationary component, to cause rotation of the rotatable component, wherein the stator comprises a first stator tooth and a second stator tooth, the first stator tooth comprising a first phase winding about a first laminator, and the second stator tooth comprising a second phase winding about a second laminator;
generating a first radial force on the spindle motor that is substantially equal and opposite of a second radial force on the spindle motor, wherein the first radial force on the spindle motor is generated by way of a predetermined position for the first stator tooth, and the second radial force on the spindle motor is generated by way of a predetermined position for the second stator tooth; and
simultaneously energizing the first phase winding and the second phase winding to cause the interaction of the stator with the magnet for a net rotational torque.

18. The method as in claim 17, wherein the second stator tooth is situated at 180 degrees circumferentially about the stator from the first stator tooth.

19. The method as in claim 17, wherein the first stator tooth is situated axially above or axially below the second stator tooth.

20. The method as in claim 17, further comprising energizing the second phase winding substantially the same as the first phase winding, to generate a second phase winding rotating force that is substantially similar to a first phase winding rotating force.
